(19) United States
(12) Patent Application Publication
(10) Pub. No.: US 2020/0057025 A1
(43) Pub. Date: Feb. 20, 2020

(54) REDUCTION OF CORE RESPONSE DEPENDENCE ON RADIUS OF FIRST PIPE IN CORROSION DETECTION TOOLS

(71) Applicant: Halliburton Energy Services, Inc., Houston, TX (US)

(72) Inventors: Luis Emilio San Martin, Houston, TX (US); Thomas Louis Yonley, Houston, TX (US)

(73) Assignee: Halliburton Energy Services, Inc., Houston, TX (US)

(21) Appl. No.: 15/736,474

(22) PCT Filed: Aug. 12, 2016
(86) PCT No.: PCT/US16/46846

§ 371 Date: Dec. 14, 2017

(51) Int. Cl. G01N 27/82; E21B 47/00

(52) U.S. Cl. CPC G01N 27/82; E21B 47/00

(57) ABSTRACT

Systems and methods for corrosion detection of downhole tubulars. A method may include disposing a corrosion detection tool in a wellbore, wherein the corrosion detection tool comprises a transmitter comprising a segmented magnetic core, wherein the segmented magnetic core is interspersed with a sense coil and comprises segments with a core air gap between each segment; measuring a signal at a shallow mode to provide a shallow mode measurement; measuring a signal at a deep mode to provide a deep mode measurement; estimating an inner-most subterranean tubular parameter based on the shallow mode measurement; estimating an outer-most subterranean tubular parameter based on the deep mode measurement; and transmitting the inner-most subterranean tubular parameter and the outer-most subterranean tubular parameter to a wellbore surface.

### BACKGROUND

For oil and gas exploration and production, a network of wells, installations and other conduits may be established by connecting sections of metal pipe together. For example, a well installation may be completed, in part, by lowering multiple sections of metal pipe (i.e., a casing string) into a borehole, and cementing the casing string in place. In some well installations, multiple casing strings are employed (e.g., a concentric multi-string arrangement) to allow for different operations related to well completion, production, or enhanced oil recovery (EOR) options.

Corrosion of metal pipes is an ongoing issue. Efforts to mitigate corrosion include use of corrosion-resistant alloys, coatings, treatments, and corrosion transfer, among others. Also, efforts to improve corrosion monitoring are ongoing. For downhole casing strings, various types of corrosion monitoring tools are available. One type of corrosion detection tool uses electromagnetic (EM) fields to estimate pipe thickness or other corrosion indicators. As an example, an EM logging tool may collect EM log data, where the EM log data may be interpreted to correlate a level of flux leakage or EM induction with corrosion. When multiple casing strings are employed together, correctly managing corrosion detection EM logging tool operations and data interpretation may be complex.

### BRIEF DESCRIPTION OF THE DRAWINGS

These drawings illustrate certain aspects of some examples of the present disclosure, and should not be used to limit or define the disclosure.

FIG. 1 is a schematic illustration of an example operating environment for a corrosion detection tool.

FIG. 2 is a schematic illustration of an example transmitter with a segmented magnetic core.

FIG. 3A is a schematic illustration of an example showing two concentric tubulars and a transmitter with a segmented magnetic core and a number of receivers disposed within a first concentric tubular with a smaller outer diameter.

FIG. 3B is a schematic illustration of an example showing two concentric tubulars and a transmitter with a segmented magnetic core and a number of receivers disposed within a first concentric tubular with a larger outer diameter.

FIG. 4A is a schematic illustration of an example showing a transmitter field distribution in a first pipe with a smaller outer diameter.

FIG. 4B is a schematic illustration of an example showing a transmitter field distribution in a first pipe with a larger outer diameter.

FIG. 5 is a schematic illustration of an example magnetic circuit representation illustrating magnetic reluctances of a transmitter, air gaps and pipes, wherein the magnetic circuit is illustrated for a configuration with N concentric pipes.

FIG. 6 is a schematic illustration of an example magnetic circuit representation illustrating magnetic reluctances of a transmitter, air gaps and equivalent reluctance of all the pipes in the configuration.

FIG. 7 is a schematic illustration of an example segmented magnetic core with a sense coil.

FIG. 8A is a schematic illustration of an example segmented magnetic core with a hole at the center, and core air gaps.

FIG. 8B is a schematic illustration of an example that shows routing of wires through a support tube through the center of a segmented magnetic core.

FIG. 9 is a schematic illustration of an example showing multiple pieces of laminae configured in a circular shape.

FIG. 10A is a schematic illustration of an example of vertical layering of laminae.

FIG. 10B is a schematic illustration of an example of horizontal layering of laminae.

FIG. 11 is a schematic illustration of an example of an approximate equivalent magnetic circuit representing a segmented core with air gaps.

FIG. 12 illustrates an example flow diagram of an inversion scheme to convert measured responses to pipe parameters.

### DETAILED DESCRIPTION

This disclosure may generally relate to systems and methods for corrosion detection of downhole tubulars, for example, such as casing and pipes. This disclosure may relate to methods to improve a stability of a transmitter-receiver system, preserving benefits of the use of a magnetic core in the transmitter.

Electromagnetic (EM) sensing may provide continuous in situ measurements of parameters related to the integrity of pipes in cased boreholes. As a result, EM sensing may be used in cased borehole monitoring applications. The use of a segmented magnetic core may assist with the optimization of corrosion detection tools by making them less sensitive to a diameter of a first pipe, thus enabling them to operate in configurations of multiple concentric pipes (e.g., 5 or more). The diameter of the first pipe may vary, for example, from about 2 inches to about 7 inches.

Corrosion detection tools may measure eddy currents to determine metal loss and use magnetic cores at the transmitters. The corrosion detection tools may use pulsed eddy current (time-domain) and may employ multiple (e.g., long, short, and transversal) coils to evaluate multiple types of defects in double pipes. The corrosion detection tools may operate in wireline logging. Additionally, a corrosion detection tool may operate on a slick-line. The corrosion detection tool may include an independent power supply and may store the acquired data on memory. A magnetic core may be used in defect detection in multiple concentric pipes.

Corrosion detection tools may comprise a transmitter-receiver system, wherein the transmitter-receiver system may comprise a transmitter, such as, for example, a solenoid transmitter and a magnetic core. The use of solenoid transmitters with magnetic cores may provide an increased signal for the same amount of current injected in the solenoid transmitter. By using a magnetic core, the inductance of the solenoid transmitter may increase and the same amount of signal may be delivered with a fraction of the current, which may be convenient to reduce cross-talk within the corrosion detection tool. The ratio of the currents required with and without the core for the same amount of signal, provided the magnetic core does not saturate, may be approximately proportional to the core relative permeability.

In corrosion detection tool applications, the response of the transmitter-receiver system may need to be stable over the range of possible applications. Two areas of concern may be the stability with a variable innermost pipe radius and stability with temperature.

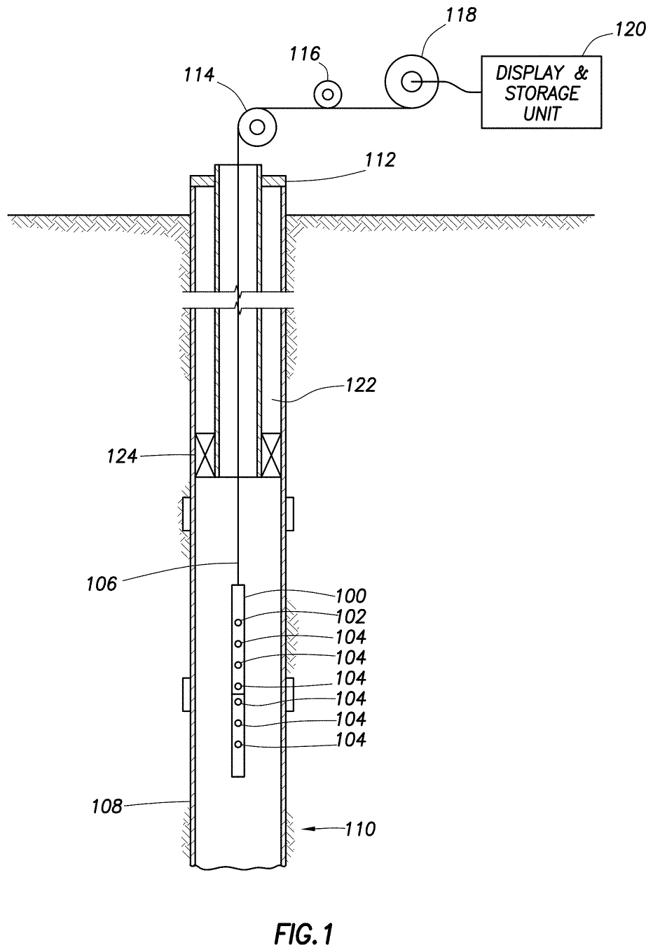

FIG. 1 illustrates an operating environment for a corrosion detection tool 100 as disclosed herein. Corrosion detection tool 100 may comprise transmitter 102 and receivers 104. Corrosion detection tool 100 may be operatively coupled to a conveyance line 106 (e.g., wireline, slickline, coiled tubing, pipe, or the like) which may provide mechanical suspension, as well as electrical connectivity, for corrosion detection tool 100. Conveyance line 106 and corrosion detection tool 100 may extend within casing string 108 to a desired depth within the wellbore 110. Conveyance line 106, which may include one or more electrical conductors, may exit wellhead 112, may pass around pulley 114, may engage odometer 116, and may be reeled onto winch 118, which may be employed to raise and lower the tool assembly in the wellbore 110. Signals recorded by corrosion detection tool 100 may be stored on memory and then processed by display and storage unit 120 after recovery of corrosion detection tool 100 from wellbore 110. Alternatively, signals recorded by corrosion detection tool 100 may be conducted to display and storage unit 120 by way of conveyance line 106. Display and storage unit 120 may process the signals, and the information contained therein may be displayed for an operator to observe and stored for future processing and reference. Display and storage unit 120 may also contain an apparatus for supplying control signals and power to the downhole tool assembly, wherein the downhole tool assembly comprises corrosion detection tool 100.

A typical casing string 108 may extend from wellhead 112 at or above ground level to a selected depth within a wellbore 110. Casing string 108 may comprise a plurality of joints or segments of casing, each segment being connected to the adjacent segments by a threaded collar.

FIG. 1 also illustrates a typical pipe string 122, which may be positioned inside of casing string 108 extending part of the distance down wellbore 110. Pipe string 122 may be production tubing, tubing string, casing string, or other pipe disposed within casing string 108. A packer 124 typically may seal the lower end of the tubing-casing annulus and may secure the lower end of the pipe string 122 to the casing. The corrosion detection tool 100 may be dimensioned so that it may be lowered into the wellbore 110 through the pipe string 122, thus avoiding the difficulty and expense associated with pulling the pipe string 122 out of the wellbore 110.

In logging systems, such as, for example, logging systems utilizing the corrosion detection tool 100, a digital telemetry system may be employed, wherein an electrical circuit may be used to both supply power to the corrosion detection tool 100 and to transfer data between display and storage unit 120 and corrosion detection tool 100. A DC voltage may be provided to the corrosion detection tool 100 by a power supply located above ground level, and data may be coupled to the DC power conductor by a baseband current pulse system. Alternatively, the corrosion detection tool 100 may be powered by batteries located within the downhole tool assembly, and/or the data provided by the corrosion detection tool 100 may be stored within the downhole tool assembly, rather than transmitted to the surface during logging (corrosion detection).

Transmission of electromagnetic fields by the transmitter 102 and the recordation of signals by the receivers 104 may be controlled by an information handling system.

Systems and methods of the present disclosure may be implemented, at least in part, with an information handling system. An information handling system may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

Alternatively, systems and methods of the present disclosure may be implemented, at least in part, with non-transitory computer-readable media. Non-transitory computer-readable media may include any instrumentality or aggregation of instrumentalities that may retain data and/or instructions for a period of time. Non-transitory computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

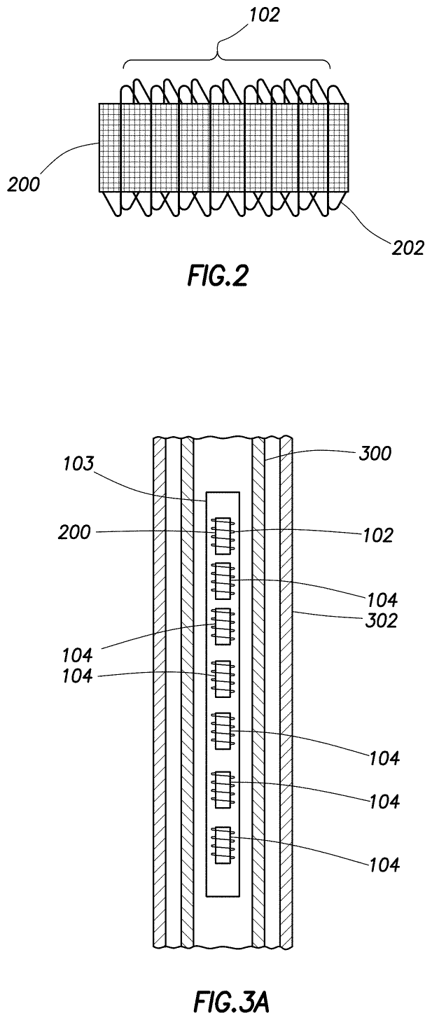

FIG. 2 schematically illustrates a transmitter 102 with a segmented magnetic core 200 inside the transmitter 102. The use of the segmented magnetic core 200 may provide an increased signal level with smaller current, which may be important to improve signal to noise and to reduce cross talk. Segmented magnetic core 200 may comprise electrical steel, ferrite or iron powder. The segmented magnetic core 200 is illustrated with a sense coil 202 interspersed to measure the excitation field at the transmitter 102. For a fixed amount of current on a transmitter 102 wire, the use of the segmented magnetic core 200 may increase a signal level. The transmitter 102 may include windings (windings of wire), wherein the windings may be interspersed with windings of the sense coil 202 that may be used to measure a field generated by the transmitter 102.

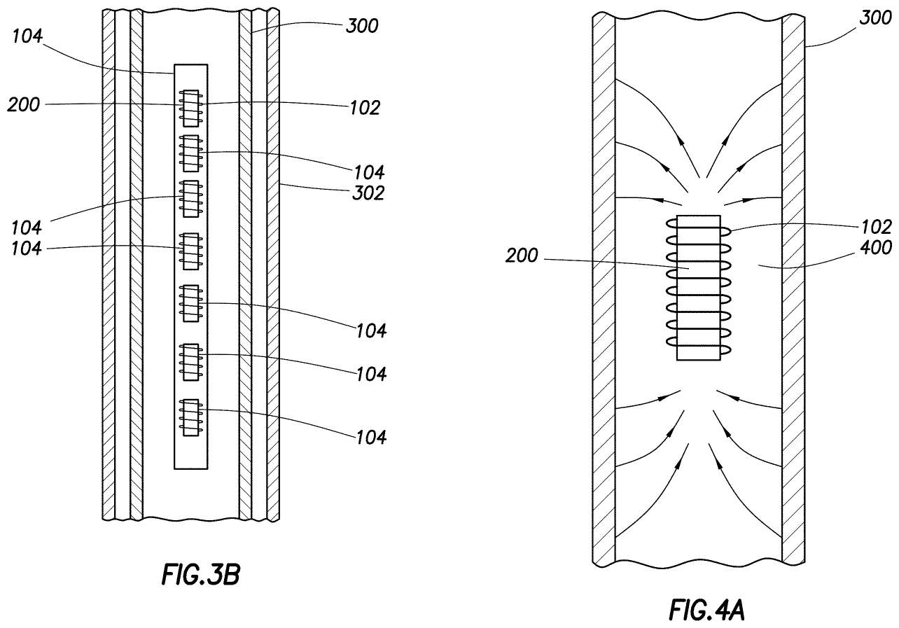

FIGS. 3A and 3B illustrate an example corrosion detection tool 100 with a tool body 103, transmitter 102 and multiple receivers 104 with two pipe configurations having two different pipe outer diameters. In FIG. 3A, the transmitter 102 with segmented magnetic core 200 and a number of receivers 104 is shown within two concentric tubulars (e.g., pipe 300 and pipe 302). This is an example schematic of the corrosion detection tool 100, but the benefit of this disclosure may be used with other tool designs. In FIG. 3B, the transmitter 102 with segmented magnetic core 200 and a number of receivers 104 is shown within two concentric tubulars (e.g., pipe 300 and pipe 302). This is an example schematic of the corrosion detection tool 100, but the benefit of this disclosure may be used with other tool designs. As illustrated, the outer diameter (“OD”) of pipe 300 has been increased on FIG. 3B as compared to FIG. 3A.

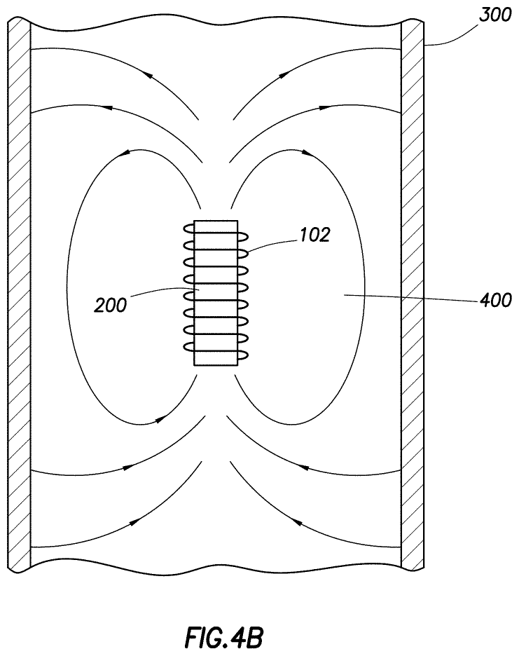

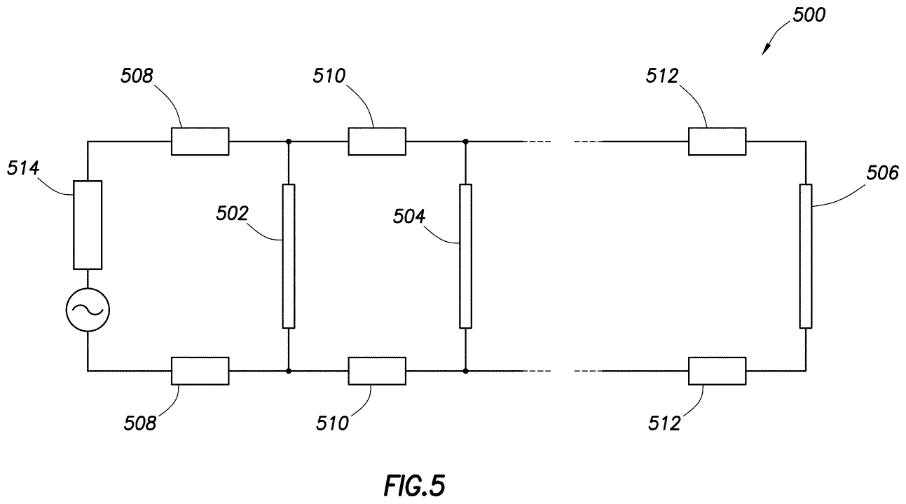

FIGS. 4A and 4B illustrate an example comparison of a transmitter 102 field distribution in pipe 300 to compare the effect of increasing the OD of a pipe from a smaller OD (FIG. 4A) to a larger OD (FIG. 4B). A field generated by the transmitter 102 and its segmented magnetic core 200, illustrated in FIGS. 4A and 4B, may be affected most strongly by the presence of the pipe 300. The situation may be modeled approximately by a magnetic circuit in which a reluctance of the segmented magnetic core 200, a reluctance of the pipes 300, 302, and a reluctance of pipe air gap 400 between the segmented magnetic core 200 and the pipe 300 may be contributors. Pipe 302, illustrated in FIG. 3A, or other additional pipes that may be present, may be represented in a magnetic circuit 500 as reluctances connected in parallel, as indicated in FIG. 5.

The magnetic circuit of FIG. 5 is shown for a configuration with n concentric pipes. As illustrated, the magnetic circuit 500 may comprise first pipe reluctance 502, second pipe reluctance 504, and n pipe reluctance 506, which are connected in parallel. The magnetic circuit 500 may also comprise first air gap reluctance 508, second air gap reluctance 510, and n air gap reluctance 512. The magnetic circuit 500 may also comprise core reluctance 514. The magnetic flux of magnetic circuit 500 may strongly be affected by the air gap reluctances 508, 510, 512. The reluctance of air may be large compared to the pipe reluctances 502, 504, 506 or core reluctance 514. So it is analogous to have larger resistance in an electrical circuit; it may prevent easy flow, in this case of magnetic field. The relative magnitude of the first air gap reluctance 508 may change significantly when the OD of pipe 300 changes, for example, from a smaller OD as shown on FIGS. 3A and 4A (e.g., about 2 inches) to a larger OD as shown on FIGS. 3B and 4B (e.g., from about 5 inches to about 7 inches). The effect of the air gap reluctances 508, 510, 512 in the magnetic circuit 500 on the magnetic flux that flows in the magnetic circuit 500 may be significant. The contributions to the reluctance that the transmitter 102 generated flux sees may contain terms from the segmented magnetic core 200, the pipes 300, 302 and the pipe air gap 400 principally and then there may be the other terms connected in parallel. The contribution of the terms connected in parallel may be relatively small. Of the mentioned terms, the largest and dominant may be the air gap reluctances 508, 510, 512 if the core reluctance 514 and pipe reluctances 502, 504, 506 are very small in comparison. This means that for a constant voltage applied to the transmitter 102, the amount of flux generated may depend on the size of the pipe air gap 400. To reduce this dependence, gaps may be included in a magnetic core to form the segmented magnetic core 200 and increase the core reluctance 514. The core reluctance 514 may be approximately proportional to the magnetic permeability times the area. The pipe 300 may have a larger area than the magnetic core and permeability of ˜100, and the magnetic core may have a small area and permeability of ˜2000 if not cut in pieces. So by cutting the magnetic core in pieces to form segmented magnetic core 200, the core reluctance 514 can be reduced to diminish the dependence of the flux on the pipe air gap 400. Additionally, cutting the magnetic core into pieces may reduce temperature dependence.

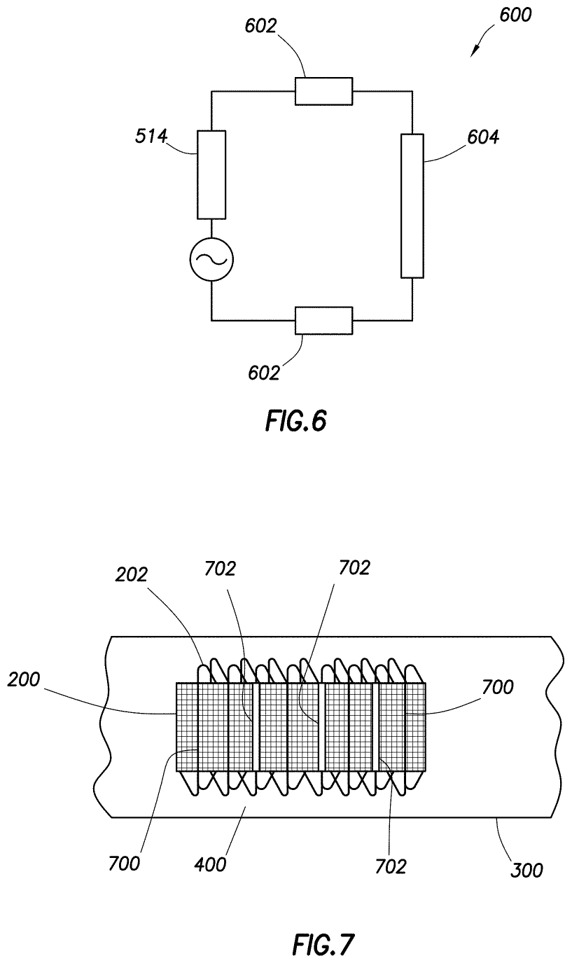

FIG. 6 illustrates an example schematic of magnetic circuit 600 illustrating the core reluctance 514, the total air gap reluctance 602, and the equivalent reluctance 604 of all pipes 300, 302 in the configuration.

In FIG. 7, a segmented magnetic core 200 with sense coil 202 is illustrated. As illustrated, segmented magnetic core 200 may comprise core segments 700. The purpose of the introduction of multiple of the core segments 700 may be to increase the reluctance of the segmented magnetic core 200 (e.g., core reluctance 514 on FIG. 5), so that the significance of the reluctance of pipe air gap 400 (e.g., first pipe reluctance 502 on FIG. 5) between the pipe 300 and the segmented magnetic core 200 compared to the reluctance of the segmented magnetic core 200 may be reduced. An additional benefit of the use of core air gaps 702 in the segmented magnetic core 200 may be to increase stability against variations caused by temperature changes. If the properties of the material are affected by changes in temperature in say 20%, the introduction of the core air gaps 702 may reduce the variation because the core air gaps 702 reduce the effective permeability of the segmented magnetic core 200 from 2000 to 100 so most of the reluctance may be due to the core air gaps 702 and the effect of the variation of 20% in the permeability of the segmented magnetic core 200 may be reduced by a factor of ˜20, because the permeability of the core air gaps 702 does not change with temperature.

As illustrated, segmented magnetic core 200 may comprise a plurality of core segments 700. Core air gaps 702 (air gaps between core segments) may be disposed between adjacent core segments 700. The segmented magnetic core 200 with core segments 700 may reduce the temperature dependence of the response and limits of the variations in transmitter 102 response due to the variations in the OD of the pipe 300. The actual size of the core air gaps 702 may be in the range of a few thousands of an inch. The increased stability with both the OD of pipe 300 and borehole temperature may make the processing of the data for the determination of the pipe 300 thicknesses more robust. The introduction of the core air gaps 702 in the segmented magnetic core 200 may reduce the equivalent relative permeability of the segmented magnetic core 200 and the parameter may be adjusted to not reduce it more than necessary for optimal performance. For example, a material that may have a segmented magnetic core 200 permeability in the range 1-2 k, such as, for example, silicon iron, the use of a few pieces (2-10) along the length of the segmented magnetic core 200 with the core air gaps 702 between pieces may be sufficient to lower the effective permeability of the segmented magnetic core 200 and increase stability. The effective relative permeability (relative value compared with permeability of air) may be between 50 and 300, with size of core air gap 702 depending on the specific material used, but typically in the range of 1-20 thousandths of an inch. Another advantage of this configuration may be that in pipe 300 of a smaller diameter (e.g., about 2 inches to about 3 inches), there may be a possibility that the segmented magnetic core 200 may be saturated. Therefore, by placing the core air gaps 702 in segmented magnetic core 200, this possibility may be prevented (this may be consistent with the high sensitivity to an OD of the pipe 300, as set forth above). The core air gaps 702 may prevent large variations in the magnetic field at the segmented magnetic core 200, which may cause saturation. A larger diameter of a pipe may range from about 5 inches to about 7 inches.

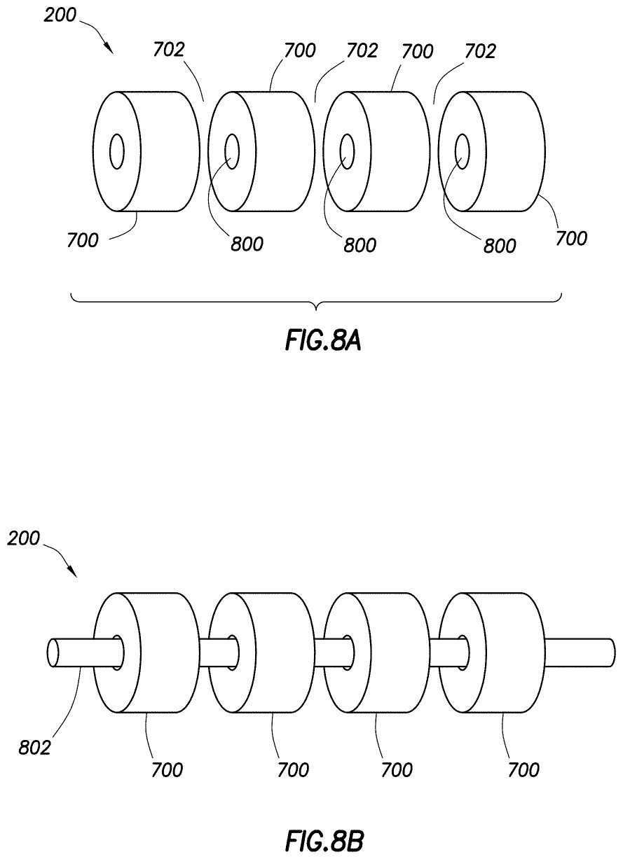

FIG. 8A illustrates the segmented magnetic core 200 with a hole 800 at the center, and core air gaps 702. Hole 800 may be a through hole extending axially through segmented magnetic core 200. While hole 800 is shown centrally located in segmented magnetic core 200, hole 800 may be offset from the center, as desired for a particular application. The segmented magnetic core 200 may comprise core segments 700 with hole 800 at the center and core air gaps 702 disposed between adjacent (magnetic) core segments 700, for example, to reduce temperature effect and sensitivity to a pipe OD. The hole 800 at the center of segmented magnetic core 200 may be necessary to optimally accommodate wires that may need to go across a transmitter 102 to reach receivers 104 or to reach other tools below. With additional reference to FIG. 8B, illustrates support tube 802 may be disposed through hole 800 of the segmented magnetic core 200. As illustrated, support tube 802 may be disposed parallel to the axis of the corrosion detection tool 100 to minimize cross talk. The core segments 700 are illustrated with the support tube 802 at the center. Inside the support tube 802, may be wires that connect receivers and other tools below. The segmented magnetic core 200 (core segments 700 thereof), in order to be more efficient, may be constructed out of laminae that may be put together to reduce eddy currents within the segmented magnetic core 200. The laminae may be isolated from each other and the drilling of a hole could break the isolation, which may increase the eddy current losses in the segmented magnetic core 200.

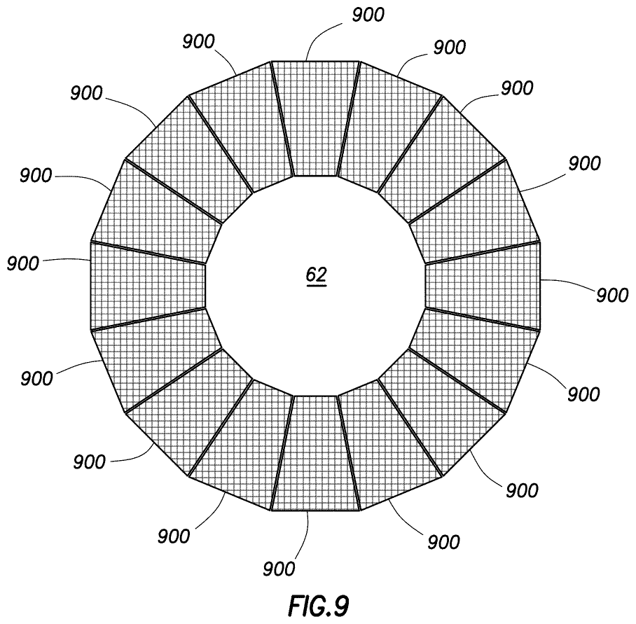

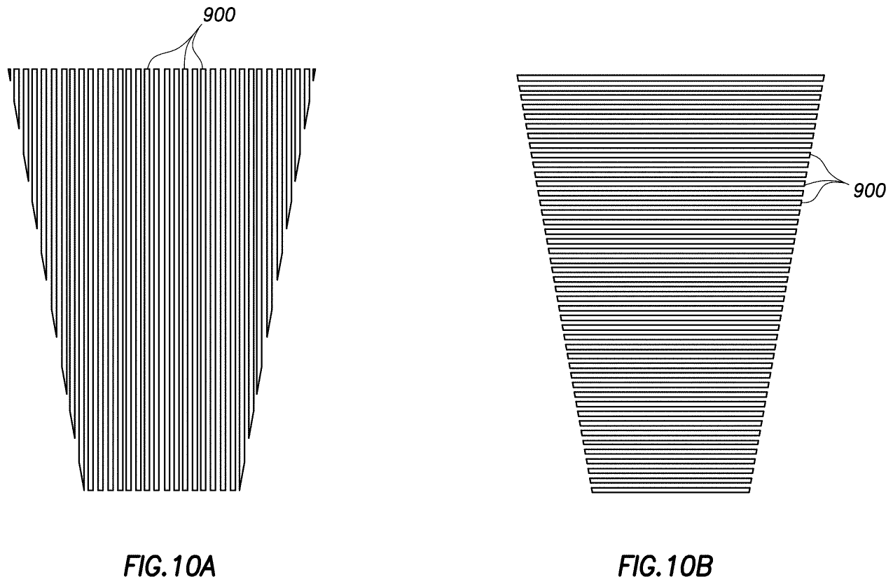

One method to build a segmented magnetic core 200 with laminae 900 may be to generate a circular shape out of multiple pieces of the laminae 900 that are placed together as illustrated in FIG. 9. The multiple pieces of the laminae 900 may be assembled with a hole 800 assembled to generate the hole 800 in the middle of the segmented magnetic core 200. The manufacturer of the pieces of the laminae 900 may avoid removing the isolation between the pieces of the laminae 900 to avoid the generation of excessive losses due to the generation of eddy currents in core segments 700. The laminae 900 that may make each magnetic core segment are illustrated in FIGS. 10A and 10B. The laminae 900 may also be a solid piece of magnetic core material. The different pieces that make a round circular magnetic core may be isolated from each other, so that eddy currents can be prevented from circulating azimuthally in closed loops. In vertical layering of the laminae 900 (FIG. 10A), horizontal layering of the laminae 900 (FIG. 10B) or a solid piece of laminae 900, the quadrangular pieces that may make the circle may be isolated from each other. The multiple pieces of the laminae 900 that may make a segmented magnetic core 200 may reduce losses due to eddy currents within the segmented magnetic core 200. The multiple pieces of the laminae 900 may not be in electrical contact with each other which may significantly reduce eddy currents.

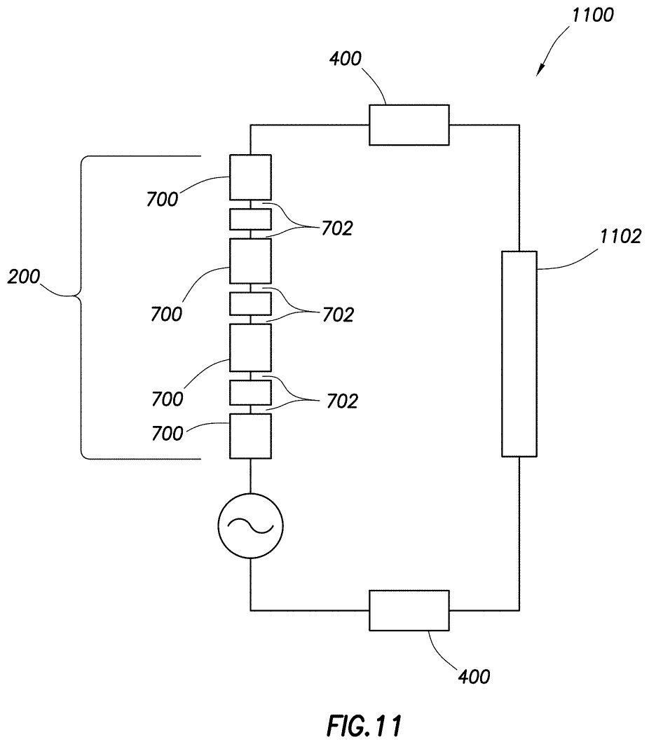

FIG. 11 illustrates an approximate equivalent magnetic circuit 1100 representing segmented magnetic core 200 comprising core segments 700 with core air gaps 702 and pipe air gap 400. Between core segments 700, there may be core air gaps 702, which reluctance increases the overall reluctance 1102 of the entire equivalent magnetic circuit 1100. The core air gaps 702 may prevent the possible saturation of the segmented magnetic core 200 that may happen when the pipe air gap 400 between the segmented magnetic core 200 and the pipe 300 is small, in the case of pipe 300 of a small diameter. As a result of core air gaps 702 between core segments 700, the equivalent relative permeability of the segmented magnetic core 200 may decrease and the flux in the equivalent magnetic circuit 1100 may be limited to prevent possible saturation of the segmented magnetic core 200.

Some of the operations that may be applied on acquired raw responses may be as follows: filtering to reduce noise; averaging multiple receiver data to reduce noise; taking the difference or the ratio of multiple voltages to remove unwanted effects such as a common voltage drift due to temperature; other temperature correction schemes such as a temperature correction table; calibration to known/expected parameter values from an existing well log; array processing (software focusing) of the data to achieve different depth of detection or vertical/azimuthal resolution.

Additionally, approaches may be employed to reduce spurious effects. For example, when using corrosion detection tool 100 with receivers 104 being at a distance from transmitter 102, double peaks may be observed in a response recorded by each receiver 104 when the corrosion detection tool 100 is scanning in the axial direction; one peak may correspond to the case when a defect and the receiver 104 are at the same axial position and a much larger peak in the response may correspond to the case where the defect is at a focused zone. With proper artifact removal algorithms, such as de-convolution or filtering, the responses may be processed such that only one peak is observed in the processed response. Processing may include calibration, noise removal, averaging, temperature corrections, array processing and artifact removal.

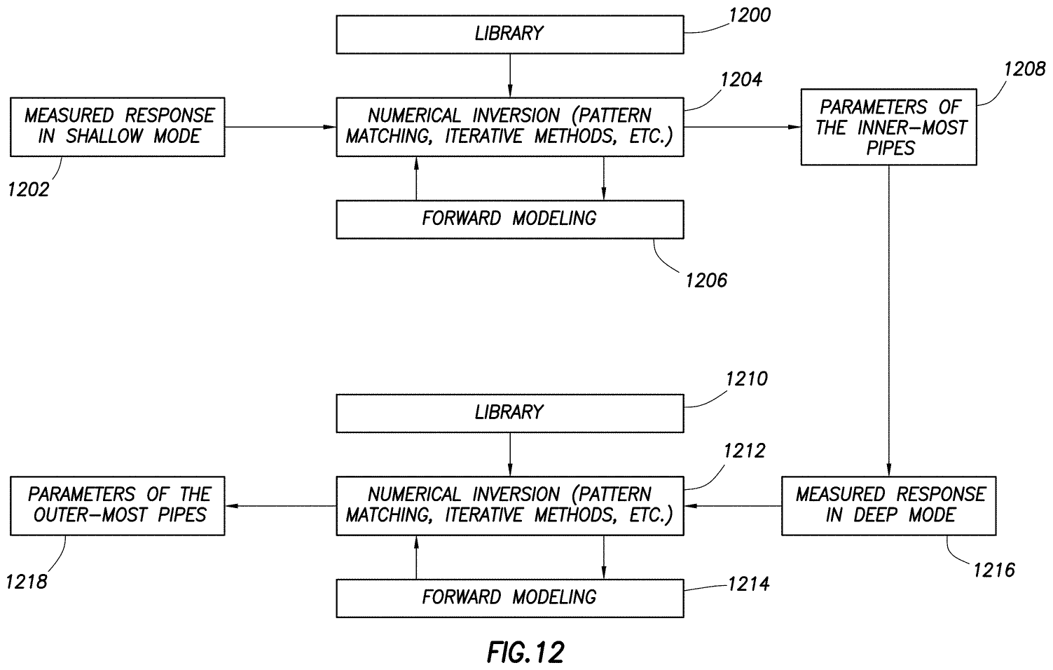

FIG. 12 is an illustration of an inversion scheme flow diagram. Block 1200 may include a library including pre-computed responses. Block 1202 may include a measured response in a shallow mode. Block 1204 may process block 1200 and block 1202 via inversion (e.g., pattern matching, iterative methods) and forward modeling, as shown in block 1206. After the processing in block 1204, parameters of the inner-most pipes may be provided, as shown in block 1208. Block 1208 may be used with a measured response in deep mode, as shown in block 1216. Block 1210 may include a library including pre-computed responses. Block 1210, block 1214, which includes forward modeling, and block 1216 may be processed by block 1212 via inversion (e.g., pattern matching, iterative methods) to provide parameters of the outer-most pipes, as shown in block 1218. An inversion scheme may include operations that may be required to convert measured responses to pipe parameters. A general description of the inversion scheme may be as follows: the measured response may be compared to signals in a library or signals from a forward modeling code and an iterative numerical optimization problem may be solved based on the difference between the two. A numerical model of the casing may be constructed for forward modeling and construction of the library. The measured response at shallow mode may be first used to estimate the inner-most pipes parameters. Shallow mode may include spacing between the transmitter 102 (not shown) and/or receivers 104 (not shown) of less than about 20 inches along the length of corrosion detection tool 100 (not shown). After estimating these, the measurement at deep mode may be used to estimate the outer-most pipe parameters. Deep mode may include spacing between the transmitter 102 (not shown) and/or receivers 104 (not shown) of more than about 20 inches along the length of corrosion detection tool 100 (not shown). The boundary of what may be deep and what may be shallow may not be clear cut. The receivers at 20 inches or more from the transmitter may be more sensitive to the deeper pipes and because of that this configuration may be considered deeper mode. This may not mean that the longer distance receivers are not sensitive to the innermost pipe but the longer distance receivers may be more sensitive to deep pipes.

Forward modeling may include a technique for determining what a given receiver 104 would measure in a given formation and environment by applying a set of theoretical equations for the sensor response. Forward modeling may be used to determine a general response of many electromagnetic logging measurements. Forward modeling may also be used for interpretation, particularly in horizontal wells and complex environments. A set of theoretical equations (the forward models) may be 1D, 2D or 3D.

Effects due to the presence of sensor housing, pad structure, and mutual coupling between receivers 104 may be corrected by using a priori information on these parameters, or by solving for some or all of them during the inversion process. Since all of these effects may be mainly additive, they may be removed by using proper calibration schemes. Multiplicative (scaling) portion of the effects may be removed in the process of calibration to an existing log or by using a calibration experiment and comparison between experiment and numerical modeling. All additive, multiplicative and any other non-linear effect may be solved for by including them in the inversion process as a parameter. By detecting and estimating the size of smaller defects, more valid predictions may be performed on the useful life-time of the tubing/casings or a decision may be made for replacing flawed sections.

The preceding description of segmented magnetic core 200 may be incorporated into a corrosion detection tool 100, for example, shown on FIG. 1. The use of gaps (e.g., core air gaps 702 and pipe air gap 400) may reduce the sensitivity to the OD of the pipe 300 facilitating the interpretation of the data. The gaps may also limit the impact of temperature effects due to segmented magnetic core 200 changes. The use of segmented magnetic core 200 as described herein may be advantageous as the corrosion detection tool 100 may produce more robust measurements able to withstand the typical condition in logging of cased wells with less variation of tool components, which may be caused by changes in the magnetic permeability of the segmented magnetic core 200.

Corrosion detection tools 100 that may be required to operate in multiple pipe configurations with pipe 300 ODs that vary, for example, between about 2 inches and about 7 inches may benefit from the increased stability that segmented magnetic core 200 may achieve. The introduction of air gaps (e.g., core air gaps 702 and pipe air gap 400) may limit the variation of magnetic flux when the air gap between pipe 300 and segmented magnetic core 200 changes, due to variations in the pipe 300 OD.

The segmented magnetic core 200 may allow more control of the temperature variations of the segmented magnetic core 200 material and possible variations in the manufacture of the segmented magnetic core 200 that may impact a value of relative magnetic permeability. The use of segmented magnetic core 200 in corrosion detection tools 100 when adapted to the development of a corrosion detection tool 100 for applications in multiple environments may be improved by introducing parameters (air gaps, e.g., core air gaps 702 and pipe air gap 400) that may give another variable in the optimization problem to prevent possible saturation of the segmented magnetic core 200 and reduce the overall sensitivity to possible variation in segmented magnetic core 200 properties due to manufacturing variability.

Accordingly, this disclosure describes systems and methods that may be used for corrosion detection of downhole tubulars. Without limitation, the systems and methods may further be characterized by one or more of the following statements:

Statement 1: A corrosion detection tool comprising: a tool body; and a transmitter comprising a segmented magnetic core, wherein the segmented magnetic core is interspersed with a sense coil and comprises segments with a core air gap between each of the segments.

Statement 2: The corrosion detection tool of statement 1, wherein the transmitter is placed in a downhole tubular, thereby forming a pipe air gap between the downhole tubular and the transmitter.

Statement 3: The corrosion detection tool of statement 1 or statement 2, wherein the core air gap is configured to increase stability against variations caused by temperature changes.

Statement 4: The corrosion detection tool of any preceding statement, wherein the core air gap is configured to reduce an equivalent relative permeability of the segmented magnetic core.

Statement 5: The corrosion detection tool of any preceding statement, wherein an effective relative permeability of the segmented magnetic core is between about 50 and about 300.

Statement 6: The corrosion detection tool of any preceding statement, wherein the core air gap is configured to prevent large variations in a magnetic field at the segmented magnetic core, wherein the large variations are capable of causing saturation.

Statement 7: The corrosion detection tool of any preceding statement, wherein the segmented magnetic core comprises a hole at the center of the segmented magnetic core.

Statement 8: The corrosion detection tool of statement 7, wherein the hole at the center of the segmented magnetic core is configured to accommodate wires passing across the transmitter to a receiver or another tool below the corrosion detection tool.

Statement 9: The corrosion detection tool of statement 7 or statement 8, wherein the hole at the center of the segmented magnetic core is configured with guide wires and to minimize crosstalk.

Statement 10: The corrosion detection tool of any preceding statement, wherein the segmented magnetic core comprises laminae, wherein the laminae are configured to reduce eddy currents within the segmented magnetic core, wherein each of the laminae is isolated from other laminae.

Statement 11: The corrosion detection tool of statement 10, wherein in the laminae are circular

Statement 12: The corrosion detection tool of any preceding statement, wherein the core air gap is configured to increase an overall reluctance of a circuit.

Statement 13: The corrosion detection tool of any preceding statement, wherein the core air gap is configured to limit a flux in a circuit to prevent saturation of the segmented magnetic core.

Statement 14: A method comprising: disposing a corrosion detection tool in a wellbore, wherein the corrosion detection tool comprises a transmitter comprising a segmented magnetic core, wherein the segmented magnetic core is interspersed with a sense coil and comprises segments with a core air gap between each of the segments; measuring a first signal at a shallow mode to provide a shallow mode measurement; measuring a second signal at a deep mode to provide a deep mode measurement; estimating an inner-most subterranean tubular parameter based, at least in part, on the shallow mode measurement; estimating an outer-most subterranean tubular parameter based, at least in part, on the deep mode measurement; and transmitting the inner-most subterranean tubular parameter and the outer-most subterranean tubular parameter to a wellbore surface.

Statement 15: The method of statement 14 further comprising correcting effects due to a presence of a sensor housing, a pad structure, and a mutual coupling between sensors.

Statement 16: The method of statement 15, wherein the correcting comprises utilizing a priori information during an inversion process.

Statement 17: The method of any one of statements 14 to 16, wherein the core air gap is configured to increase stability against variations caused by temperature changes.

Statement 18: The method of any one of statements 14 to 17, wherein the core air gap is configured to reduce an equivalent relative permeability of the segmented magnetic core.

Statement 19: The method of anyone of statements 14 to 18, wherein an effective relative permeability of the segmented magnetic core is between about 50 and about 300.

Statement 20: The method of any one of statements 14 to 19, wherein the core air gap is configured to prevent large variations in a magnetic field at the segmented magnetic core, wherein the large variations are capable of causing saturation.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A corrosion detection tool comprising:
a tool body; and
a transmitter comprising a segmented magnetic core, wherein the segmented magnetic core is interspersed with a sense coil and comprises segments with a core air gap between each of the segments.

2. The corrosion detection tool of claim 1, wherein the transmitter is placed in a downhole tubular thereby forming a pipe air gap between the downhole tubular and the transmitter.

3. The corrosion detection tool of claim 1, wherein the core air gap is configured to increase stability against variations caused by temperature changes.

4. The corrosion detection tool of claim 1, wherein the core air gap is configured to reduce an equivalent relative permeability of the segmented magnetic core.

5. The corrosion detection tool of claim 1, wherein an effective relative permeability of the segmented magnetic core is between about 50 and about 300.

6. The corrosion detection tool of claim 1, wherein the core air gap is configured to prevent large variations in a magnetic field at the segmented magnetic core, wherein the large variations are capable of causing saturation.

7. The corrosion detection tool of claim 1, wherein the segmented magnetic core comprises a hole at the center of the segmented magnetic core.

8. The corrosion detection tool of claim 7, wherein the hole at the center of the segmented magnetic core is configured to accommodate wires passing across the transmitter to a receiver or another tool below the corrosion detection tool.

9. The corrosion detection tool of claim 7, wherein the hole at the center of the segmented magnetic core is configured with guide wires and to minimize crosstalk.

10. The corrosion detection tool of claim 1, wherein the segmented magnetic core comprises laminae, wherein the laminae are configured to reduce eddy currents within the segmented magnetic core, wherein each of the laminae is isolated from other laminae.

11. The corrosion detection tool of claim 10, wherein in the laminae are circular.

12. The corrosion detection tool of claim 1, wherein the core air gap is configured to increase an overall reluctance of a circuit.

13. The corrosion detection tool of claim 1, wherein the core air gap is configured to limit a flux in a circuit to prevent saturation of the segmented magnetic core.

14. A method comprising:
disposing a corrosion detection tool in a wellbore, wherein the corrosion detection tool comprises a transmitter comprising a segmented magnetic core, wherein the segmented magnetic core is interspersed with a sense coil and comprises segments with a core air gap between each of the segments;
measuring a first signal at a shallow mode to provide a shallow mode measurement;
measuring a second signal at a deep mode to provide a deep mode measurement;
estimating an inner-most subterranean tubular parameter based, at least in part, on the shallow mode measurement;
estimating an outer-most subterranean tubular parameter based, at least in part, on the deep mode measurement; and
transmitting the inner-most subterranean tubular parameter and the outer-most subterranean tubular parameter to a wellbore surface.

15. The method of claim 14 further comprising correcting effects due to a presence of a sensor housing, a pad structure, and a mutual coupling between sensors.

16. The method of claim 15, wherein the correcting comprises utilizing a priori information during an inversion process.

17. The method of claim 14, wherein the core air gap is configured to increase stability against variations caused by temperature changes.

18. The method of claim 14, wherein the core air gap is configured to reduce an equivalent relative permeability of the segmented magnetic core.

19. The method of claim 14, wherein an effective relative permeability of the segmented magnetic core is between about 50 and about 300.

20. The method of claim 14, wherein the core air gap is configured to prevent large variations in a magnetic field at the segmented magnetic core, wherein the large variations are capable of causing saturation.
